(19) United States
(12) Patent Application Publication
(10) Pub. No.: US 2009/0025760 A1
(43) Pub. Date: Jan. 29, 2009

(54) MEDICAL AND DENTAL TOOL CLEANING DEVICE

(76) Inventor: Oscar Ciampaglia, Indianapolis, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/782,256

(22) Filed: Jul. 24, 2007

(51) Int. Cl. B08B 13/00

(52) U.S. Cl. 134/115 R; 134/137

(57) ABSTRACT

An apparatus for cleaning of dental instruments and medical instruments. The apparatus includes a body for holding such instruments that is biased apart from an immersion tank. The retained instruments can be lowered into the immersion tank by hand operation. After the hand pressure is removed, the instruments are biased to pull out of the immersion bath. The instruments are then blown dry by pressurized gas.

### FIELD OF THE INVENTION

The present invention relates to apparatus and methods for cleaning medical instruments, and in particular, for cleaning of medical or dental instruments with a cleaning fluid and pressurized air.

### BACKGROUND OF THE INVENTION

Numerous apparatus wash and disinfect objects such as medical or dental instruments or devices. Apparatus that wash and disinfect generally require that any stubborn soil be manually removed by presoaking followed by a manual scrubbing. A typical apparatus that washes and disinfects applies a cleaning composition and a disinfectant to an object. Some washing and disinfecting apparatus employ a sonication bath. However, stubborn soils must still be removed by a presoak with manual scrubbing.

There remains a need for an apparatus or system that dislodges stubborn soils from objects such as medical or dental instruments or devices without the need for manual scrubbing.

### SUMMARY OF THE INVENTION

In one embodiment there is an apparatus for cleaning of medical instruments in a fluid. The apparatus includes a generally enclosed body defining a plurality of apertures each adapted and configured for supporting a medical instrument, the body having an internal cavity. The apparatus includes a tank for holding a quantity of the fluid located beneath the body, the tank having a shape adapted and configured to permit the tank to pass into the cavity. At least a portion of the supported instrument is in contact with the fluid when the tank is in the cavity.

In another embodiment there is an apparatus for cleaning of medical instruments in a fluid. The apparatus includes a generally enclosed body for supporting a plurality of medical instruments. The apparatus includes a tank for holding a quantity of the fluid located beneath the body. The apparatus includes a support for slidingly positioning said tank relative to said body, and means for biasing said tank away from said body in the direction of sliding.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these myriad combinations is excessive and unnecessary.

These and other features and aspects of different embodiments of the present invention will be apparent from the claims, specification, and drawings.

### DESCRIPTION OF THE DRAWINGS

FIG. 1 is a front elevational view of an apparatus according to one embodiment of the present invention.

FIG. 2 is a top plan view of the apparatus of FIG. 1.

FIG. 3 is a left side elevational view of the apparatus of FIG. 1.

FIG. 4 is a view of the apparatus of FIG. 3 with a medical tool in the cleaning bath.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The present invention pertains to apparatus and methods for the ease of cleaning medical or dental instruments, especially in a dentist's office. In one embodiment, the invention includes a body that holds a plurality of medical or dental instruments. The instruments are cleaned by pushing downward on the body such that the distal end of the instruments are immersed in a bath of cleaning fluid. In some embodiments, the tank further includes an ultrasonic transducer for ultrasonic cleaning of the instruments. After the instruments have been immersed for a sufficient period of time, the operator removes their hand pressure, the enclosure being biased (by springs or counter weights) to move the instruments up and out of the bath. In the non-bathing position, pressurized air is blown over the wetted instruments to complete the cleaning cycle.

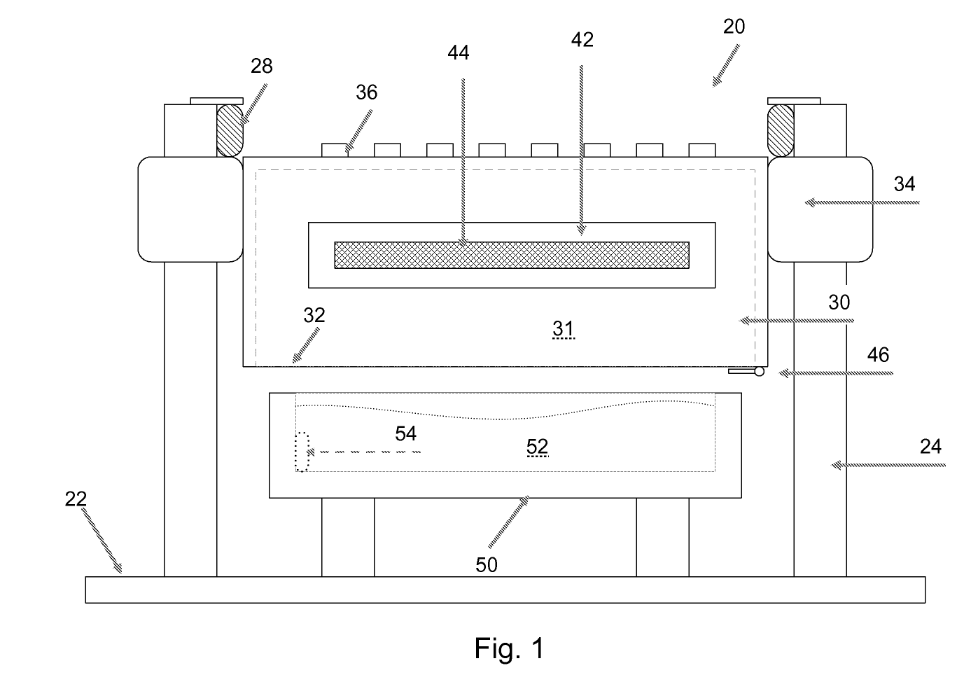

FIGS. 1, 2, 3, and 4 show various views of a medical or dental tool cleaning apparatus 20, according to one embodiment of the present invention. Each of these Figures includes one or more internal features shown with dotted lines. Apparatus 20 includes a holding body enclosure 30 supported above a tank assembly 50 by a support structure 22. In one embodiment, support structure 22 includes a pair of cylindrical guide posts 24 that extend upwardly from a base 22. Enclosed holding body 30 is slidingly supported on each guide post 24 by an alignment ear 34, such that body 30 can slide relative to support structure 22. Holding tank 50 is preferably attached to base 22.

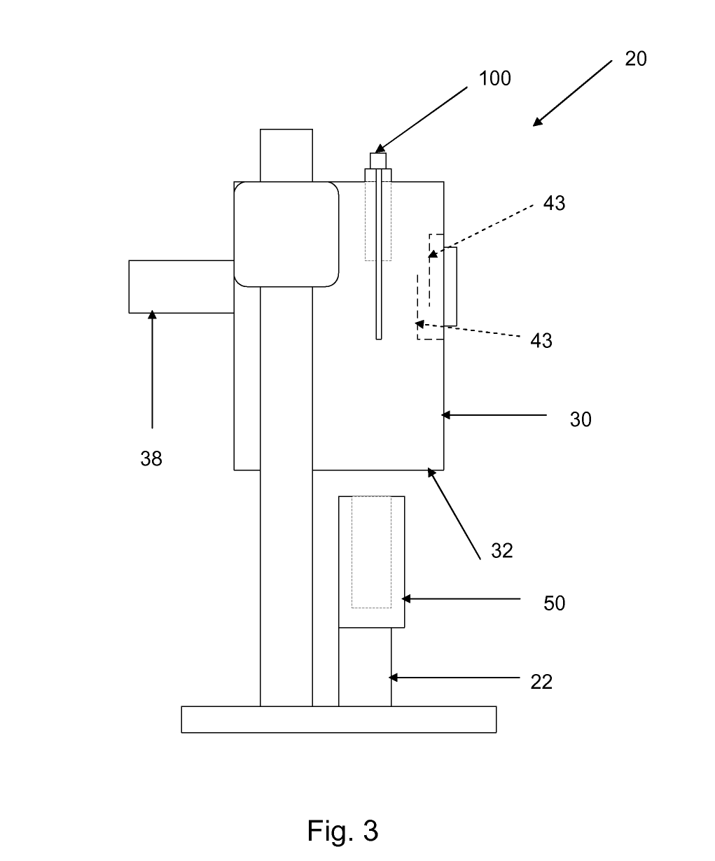

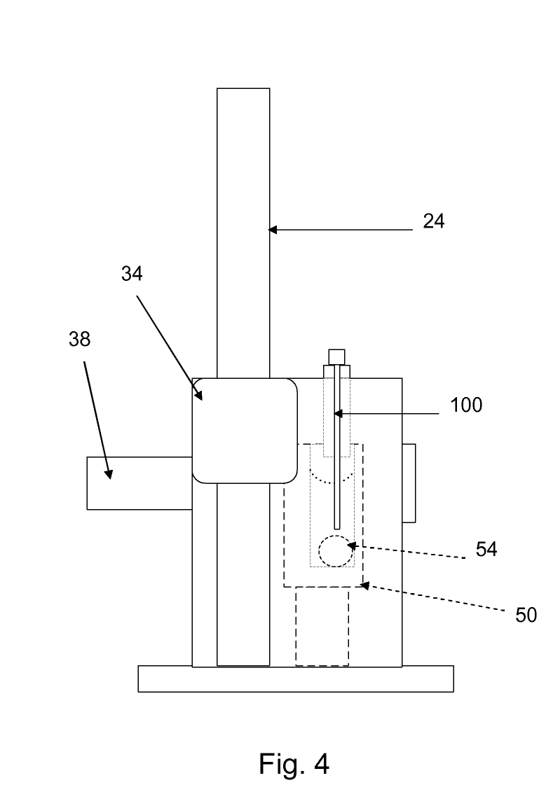

Enclosed holding body 30 includes a top wall, four surrounding side walls, and a generally open bottom 32. The top wall and four side walls of body 30 define an interior cavity 31. The top wall of body 30 includes a plurality of medical or dental tool holders 36. Each tool holder 36 is adapted and configured to support the base of a tool 100, such that the body of the tool and the distal tip extend downwardly through an aperture in tool holder 36 (as best seen in FIGS. 3 and 4).

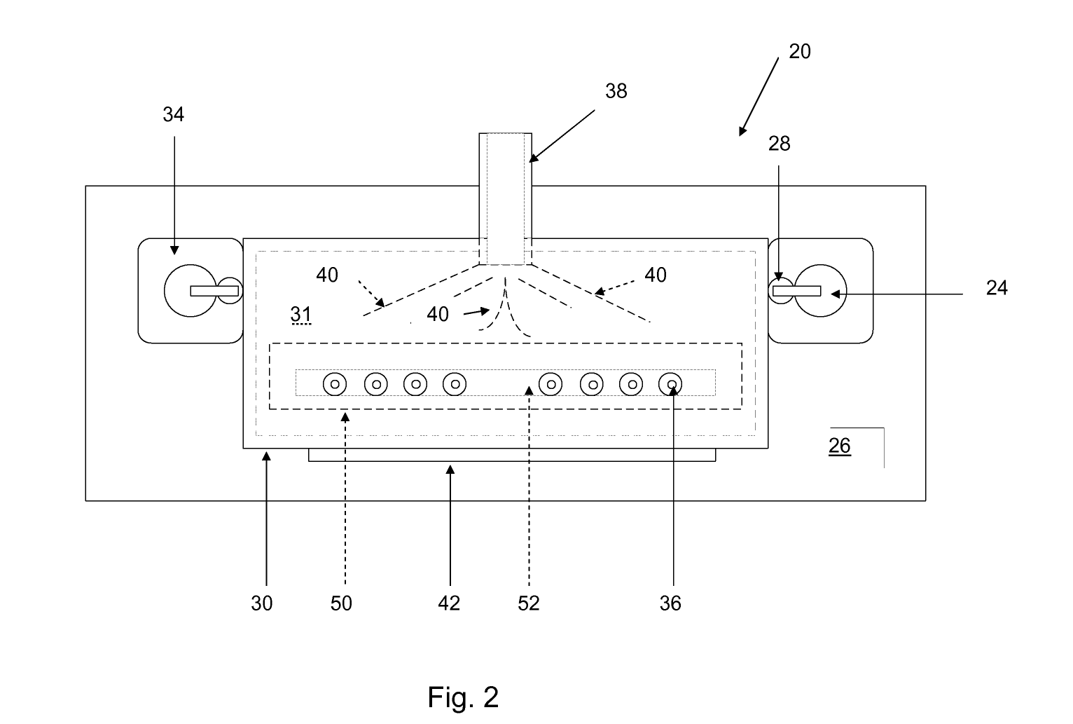

As best seen in FIGS. 2 and 3, body 30 includes an air inlet 38 and an air exhaust port 42. In one embodiment, pressurized air is introduced into air inlet 38 and flows within cavity 31, and exits from exhaust port 42 and also from the open bottom 32. Referring to FIG. 2, a plurality of internal angled air deflectors 40 guide the incoming air into a pattern that provides a scrubbing action on the suspended tools 100. As best seen in FIG. 3, air inlet 30, exhaust port 42 and the distal end of tool 100 are generally aligned. Deflectors 40 (not shown in FIG. 3) are placed within enclosure 30 in between inlet 38 and tool holder 36.

Since the exhausting air may contain droplets of cleaning fluid or particles previously embedded in the tool, exhaust port 42 preferably includes a screen 44 for capturing such droplets and particles. In some embodiments, a plurality of air-deflecting baffles 43 are placed in front of exhaust port 42 in order to reduce the velocity of the exhausting from port 42 (see FIG. 3). In yet other embodiments, body 30 includes a movable bottom wall (not shown) that limits the downward flow of air through bottom 32. Such bottom walls would preferably be spring-loaded to move out of the way when tank 50 is moved within cavity 31.

Immersion tank 50 is placed beneath holding body 30. Referring to FIGS. 1 and 2, immersion tank 50 has an external shape that fits within the side walls of body 30 (as best seen in FIG. 2). Tank 50 includes a cavity in which a cleaning fluid 52 is placed. In some embodiments, tank 50 further includes one or more ultrasonic transducers 54, which provide a disruptive high frequency pressure within cleaning fluid 52. Tank 50 preferably includes a drain for removal of cleaning fluid 52.

Enclosure 30 is biased apart from immersion tank 50 by one or more springs 28. As shown in FIG. 1, springs 28 support the weight of enclosure 30 from guide posts 24 and maintain it in a position spaced apart and above tank 50. Springs 28 are adapted and configured to permit hand pressure from an operator to move enclosure 30 downward toward tank 50 as best seen in FIG. 4. Enclosure 30 is preferably maintained in the downward position by hand pressure from the operator, although in some embodiments there is a latching mechanism (not shown) to maintain enclosure 30 over and surrounding tank 50. When the operator removes the hand pressure, springs 28 return enclosure 30 to the upward position, shown in FIGS. 1 and 3.

Although what has been shown and described is an enclosure 30 that is biased by springs on support 22, the present invention also contemplates those embodiments in which the enclosed body is biased under the influence of gravity by counterweights. As one example, the guide posts are hollow with interiors adapted and configured for the vertical movement of a counterweight. The enclosure is attached on each side to a wire attached to a respective counterweights within a guide post. When the enclosed body is in the upward position, the counterweights are near the bottom of the interior of the respective guide post. When the body is pushed down toward the immersion tank, the counterweights are lifted. Since the counterweights weigh more than the body, when hand pressure on the body is removed, the counterweights act to restore the body to the upward position.

In some embodiments, a switch 46 is used to disable the flow of pressurized air when body 30 is lowered over tank 50. Referring to FIG. 1, in one embodiment pressure switch 46 is attached to body 30 and is actuated by contact with tank 50. In yet other embodiments, switch 46 is attached to tank 50 or support structure 22. Preferably, switch 46 changes the state of the circuit that energizes a solenoid (not shown) that controls the flow of pressurized gas into inlet 38.

Enclosure 30 is lowered over immersion tank 50 by hand pressure applied by the operator. A plurality of medical or dental tools 100 are placed in enclosure 30, each tool being within a separate holder 36. Referring to FIG. 4, holding body 30 can be guided downward along guide post 24 to a position where immersion tank 50 is located in internal cavity 31. In this position, the distal end of tool 100 is immersed in the bath of cleaning fluid 52, preferably for one to two minutes. By the action of one or more switches, including switch 46, ultrasonic transducer 54 is activated when enclosure 30 is lowered and enhances the cleaning of tool 100 within bath 52.

When the operator removes the hand pressure that lowered enclosure 30, the action of springs 28 bias enclosure 30 upward and away from immersion tank 50 (such as is shown in FIG. 3). In this upper position, pressurized air from inlet 30 is blown over the previously bathed tool 100 to remove any excess cleaning fluid and/or particles. The preferred air pressure is in the range of about 35 to 55 psig.

Although what has been shown and described is a holding body that is lowered over a tank, the present invention also contemplates those embodiments in which the tank is raised upward toward the holding body.

While the inventions have been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. An apparatus for cleaning of medical or dental instruments in a fluid, comprising:
a generally enclosed body defining a plurality of apertures each adapted and configured for supporting a medical instrument, said body having an internal cavity and a generally open bottom having a shape;
a tank for holding a quantity of the fluid, said tank being located beneath said body, said tank having shape adapted and configured to permit said tank to pass through the bottom shape and into the cavity; and
a support for positioning said tank under said body;
wherein at least a portion of the supported instrument is in contact with the fluid when said tank is in the cavity.

2. The apparatus of claim 1, wherein said body is slidable relative to said stand and toward said tank.

3. The apparatus of claim 1, wherein said tank is slidable relative to said stand and toward said body.

4. The apparatus of claim 1, wherein said body includes an inlet for a supply of pressurized gas.

5. The apparatus of claim 1, wherein said body includes a plurality of deflectors for directing pressurized gas toward a plurality of supported instruments.

6. The apparatus of claim 1, which further comprises an ultrasonic transducer for directing ultrasonic energy toward the portion of the supported instrument.

7. The apparatus of claim 1, which further comprises a switch for providing a signal corresponding to the placement of said tank within said cavity.

8. The apparatus of claim 1, which further comprises a spring for biasing said tank apart from said body.

9. An apparatus for cleaning of medical or dental instruments in a fluid, comprising:
a generally enclosed body defining a plurality of apertures each adapted and configured for supporting a medical instrument, said body having an internal cavity;
a tank for holding a quantity of the fluid, said tank being located beneath said body, said tank having shape adapted and configured to permit said tank to be positioned within the cavity;
a support for slidingly positioning said tank relative to said body; and
means for biasing said tank away from said body in the direction of sliding.

10. The apparatus of claim 9, wherein said biasing means is a spring.

11. The apparatus of claim 9, wherein said biasing means is by supporting said tank under said body, and gravity biases said tank away from said body.

12. The apparatus of claim 9, wherein said body slides downward over said tank, and said biasing means is adapted and configured to support the weight of said body above said tank.

13. The apparatus of claim 9, wherein said body includes an inlet for a supply of pressurized gas and a plurality of deflectors for directing pressurized gas toward a plurality of supported instruments.

14. The apparatus of claim 9, which further comprises an ultrasonic transducer for directing ultrasonic energy toward the portion of the supported instrument.

15. The apparatus of claim 9, which further comprises a switch for providing a signal corresponding to the placement of said tank within said cavity.
